(19) United States
(12) Patent Application Publication
(10) Pub. No.: US 2005/0283826 A1
(43) Pub. Date: Dec. 22, 2005

(54) Systems and methods for performing secure communications between an authorized computing platform and a hardware component

(75) Inventor: Thomas Tahan, San Diego, CA (US)

Correspondence Address: Michael K. Hsu;MARTINE & PENILLA, LLP, Suite 170, 710 Lakeway Drive, Sunnyvale, CA, 94085, US

(73) Assignee: SUN MICROSYSTEMS, INC., SANTA CLARA, CA (US)

(21) Appl. No.: 10/986,526

(22) Filed: Nov. 10, 2004

Related U.S. Application Data
(60) Provisional application No. 60/582,206, filed on Jun. 22, 2004.

(51) Int. Cl. G06F 17/30

(52) U.S. Cl. 726/2

(57) ABSTRACT

A hardware-based method for performing secure communications between an authorized computing platform (ACP) and a hardware component is provided. In this method, a secure communication path is established between the ACP and the hardware component. Thereafter, data transmitted over the secure communication path between the ACP and the hardware component is protected.

### CROSS REFERENCE TO RELATED APPLICATIONS

This application claims the benefit of U.S. Provisional Application No. 60/582,206, filed Jun. 22, 2004. The disclosure of the provisional application is incorporated herein by reference.

### BACKGROUND OF THE INVENTION

1. Field of the Invention

The present invention relates generally to data security and, more particularly, to methods and systems for securing communications between an authorized computing platform and a hardware component.

2. Description of the Related Art

A computer system may be comprised of multiple components. These may include the CPU and hardware components in communication with the CPU. In some situations, a hardware component is not directly attached to the CPU. Instead, communications between the CPU and the hardware component must flow through one or more peripheral busses or networks, passing through one or more switches, and the bus or network fabric may be shared by multiple components. In such a situation, there is a need to protect communications between the CPU and the hardware component.

Cryptographic methods are often used to protect communications flowing over media that is not possible or practical to secure otherwise. A cryptographic connection is established between the communicating components, capable of providing source component authentication, integrity and privacy for the communications. However, there may be a need for source authentication beyond the component level, authenticating further that the source of communications is software authorized by an authority for the system or network.

Shortcomings of currently available systems are that there is no secure location on a platform to store secret or private keys, and there is no way to provide authentication that the source is authorized software executing on the platform. A Trusted Platform Module (TPM) could provide such a capability if it is built onto the motherboard in direct communication with the CPU. However, a server's TPM may be too complex to build into a motherboard, and the server TPM may instead be attached to the platform as a peripheral accessed over a potentially shared peripheral bus. With such an architecture, the TPM peripheral itself is a hardware component remote from the CPU (i.e., not on the motherboard directly attached to the CPU), and communications between the CPU and the TPM peripheral need to be cryptographically protected. Hence the server needs another location to store secret and private keys for the CPU that can be accessed by the CPU over a direct connection.

In view of the foregoing, there is a need to provide systems and methods for securing communications between an authorized computing platform and a hardware component suited to the requirements of a server system.

### SUMMARY OF THE INVENTION

Broadly speaking, the present invention fills these needs by providing systems and methods for providing performing secure communications between an authorized computing platform (ACP) and a hardware component. It should be appreciated that the present invention can be implemented in numerous ways, including as a process, an apparatus, a system, computer readable media, or a device. Several inventive embodiments of the present invention are described below.

In accordance with a first aspect of the present invention, a hardware-based method for performing secure communications between an authorized computing platform (ACP) and a hardware component is provided. In this method, a secure communication path is established between the ACP and the hardware component. Thereafter, data transmitted over the secure communication path between the ACP and the hardware component is protected.

In accordance with a second aspect of the present invention, an ACP for securely communicating with a hardware component is provided. The ACP includes logic for establishing a secure communication path with the hardware component and logic for protecting data transmitted over the secure communication path with the hardware component.

In accordance with a third aspect of the present invention, a hardware component for securely communicating with an ACP is provided. The ACP includes logic for establishing a secure communication path with the ACP and logic for protecting data transmitted over the secure communication path with the ACP.

In accordance with a fourth aspect of the present invention, a system for secure communications between an ACP and a hardware component is provided. The ACP includes logic for establishing a secure communication path with the hardware component and logic for protecting data transmitted over the secure communication path with the hardware component, whereby the hardware component being in communication with the ACP.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of a system for securing communications between an authorized computing platform (ACP) and a hardware component, in accordance with one embodiment of the present invention.

FIG. 2 is a simplified block diagram of a more detailed overview for secure communications, in accordance with one embodiment of the present invention.

FIGS. 3A, 3B, and 3C are simplified schematic diagrams of methods for establishing a basic secure communication path and a high performance secure communication path, in accordance with one embodiment of the present invention.

FIG. 4 is a flowchart diagram of a high level overview of a method for establishing a basic secure communication path, in accordance with one embodiment of the present invention.

FIG. 5 is a simplified block diagram of a more detailed overview for providing a basic secure communication path, in accordance with one embodiment of the present invention.

FIG. 6 is a flowchart diagram of a high level overview of a method for establishing a high performance secure communication path, in accordance with one embodiment of the present invention.

FIG. 7 is a simplified block diagram of a more detailed overview for providing a high performance secure communication path, in accordance with one embodiment of the present invention.

### DETAILED DESCRIPTION

An invention is disclosed for systems and methods for performing secure communications between an authorized computing platform (ACP) and a hardware component. An ACP is a computing platform whose hardware and software has been authorized to execute by an authority for the network or system of which the hardware and the software are a part. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

### I. Performing Secure Boot of an ACP

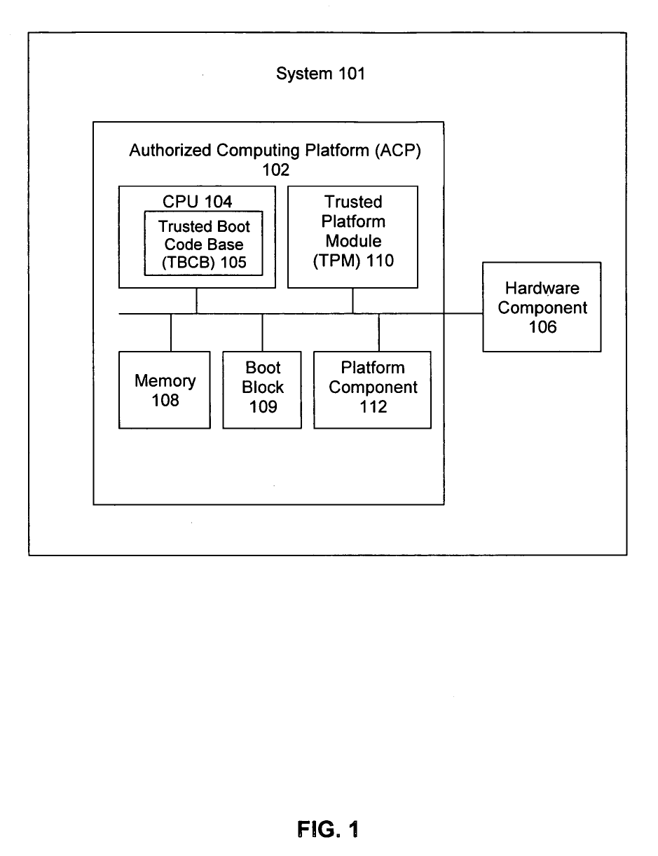

FIG. 1 is a simplified block diagram of a system for securing communications between an authorized computing platform (ACP) and a hardware component, in accordance with one embodiment of the present invention. ACP 102 is comprised of CPU 104, Trusted Platform Module (TPM) 110, memory 108, boot block 109, and platform component 112. CPU 104 executes trusted boot code base (TBCB) 105.

TBCB 105 is software authorized to execute in ACP 102 by an authority for the network of which the ACP is a part. It is assumed that a certifying authority for ACP 102 and TBCB 105 has performed an analysis assuring that the ACP and TBCB is sufficiently trustworthy. In one embodiment, when there is software other than TBCB 105 also executing on CPU 104, the TBCB utilizes the CPU's privilege levels, memory management unit, and I/O controller memory access protections to protect itself from interference or tampering by the other software, as well as by unauthorized system hardware. Examples of TBCB 105 include a trusted operating system, a security kernel, a virtual machine monitor, a hypervisor, and trusted applications alone or in combination with a trusted operating system, a security kernel, a virtual machine monitor, or a hypervisor.

Examples of hardware component 106 include a chip, Field Programmable Gate Array (FPGA), Application Specific Integrated Circuit (ASIC), a peripheral component interconnect (PCI) card, a PCI-X card, a PCI-Express card, an Infiniband communications adapter, a mezzanine card, a network appliance, a platform, a storage system, a storage subsystem, a printer, a keyboard, a mouse, a mobile phone, a personal data assistant, a service processor provided to allow management of the platform, a peripheral, a Trusted Platform Module, a Trusted Platform Module Peripheral, a Cryptographic Module compliant with the National Institute of Standards and Technology (NIST) Federal Information Processing Standards Publications (FIPS PUBS) 140-2 standard, etc.

CPU 104 may include any suitable processor. Exemplary processors include Scalable Processor Architecture (SPARC) processors, Pentium processors, PowerPC processors, Opteron processors, Xeon processors, Itanium processors, etc. Examples of memory 108 include any suitable memory types, such as static access memory (SRAM), dynamic random access memory (DRAM), etc.

One skilled in the art will appreciate that trusted platform module (TPM) 110 may be a security component specified by the Trusted Computing Group and the TPM may be used to secure a computer boot. TPM 110 may be a secure micro-controller with cryptographic functionalities. For example, TPM 110 can provide a secure boot capability for a platform, as well as a protected storage capability for storing sensitive information such as cryptographic keys and integrity measurements. In one embodiment, TPM 110 may be implemented in a chip or a chip set that is physically attached to a system board (e.g., a motherboard) or logically bound to the platform. Also, there may be more than one TPM for a platform.

Boot block 109 may be any suitable type of memory component, including read-only memory (ROM), programmable read-only memory (PROM), electrically erasable programmable read-only memory (EEPROM), etc.

Platform component 112 may include any component with computational and input/output ability. Exemplary platform component 112 includes filed programmable gate arrays (FPGA), application specific integrated circuits (ASIC), service processors for managing and controlling the platform, special logic in the system CPU(s), etc.

As shown in FIG. 1, CPU 104 is in communication with hardware component 106, TPM 110, memory 108, boot block 109, and platform component 112. One skilled in the art will appreciate that while CPU 104, hardware component 106, TPM 110, memory 108, boot block 109, and platform component 112 are illustrated as being interconnected on a common bus, these components may be interconnected in other ways. It is assumed that the connection between CPU 104 and TPM 110 is trustworthy such that special methods such as those described herein are not needed to secure their communications.

The embodiments described herein include systems and methods for assuring the integrity of TBCB 105 executing on CPU 104 while the TBCB is in communications with hardware component 106. This ensures that the software running on CPU 104 is actually TBCB 105, without unauthorized modifications. To ensure that the software running on CPU 104 is TBCB 105, a method for securing the boot of TBCB 105 on CPU 104 is provided, as well as a method for protecting storage used by the TBCB.

In one exemplary embodiment, ACP 102 may be a server and hardware component 106 may be a TPM peripheral (TPMP) on an I/O bus such as PCI-Express. Communications between ACP 102 and hardware component 106 go through PCI-Express switches. As there are a number of components connected to the PCI-Express switches, there is a need to protect communications between ACP 102 and hardware component 106. For example, ACP 102 may be a server that supports partitioning. The partitioning is implemented in software operating at the highest privilege level in CPU 104 or platform hardware. This software may be TBCB 105. The TPMP also supports partitioning, such that a partition in a server may access its own Platform Configuration Registers (PCRs) and protected storage, and not that of another partition. Thus partition tags accompany transmissions between ACP 102 and hardware component 106. Hardware component 106 needs a way to know that the transmissions and partition tags from ACP 102 actually originated in the ACP and haven't been corrupted while in transmission. Similarly, ACP 102 needs a way to know that transmissions and partition tags from hardware component 106 actually originated in the hardware component and haven't been corrupted while in transmission. The cryptographic methods described herein provide such protections. To implement such protections, ACP 102 includes a secure location to store its keys, and methods such that TBCB 105 can access its keys and not some corrupt software masquerading as the TBCB. TPM 110 provides such protections for ACP 102's key store. TPM 110 may be a basic low-cost TPM having sufficient capability to store integrity measurements for TBCB 105 and maintain ACP's keys in protected storage. TPM 110 may be located on one of the ACP's main system boards and connected to CPU 104 over a local bus.

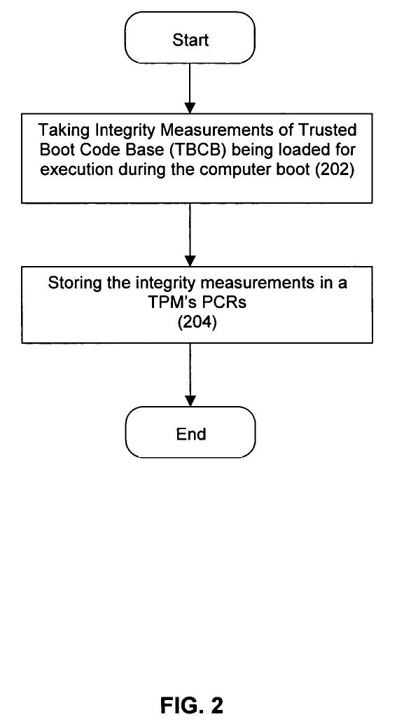

FIG. 2 is a simplified block diagram of a more detailed overview for secure communications, in accordance with one embodiment of the present invention. As shown in FIG. 2, in performing a secure boot, integrity measurements of the TBCB components are taken in operation 202 and stored in TPM's PCRs in operation 204. One skilled in the art will understand that, according to Trusted Computing Group standards, the integrity measurement process starts from a Core Root of Trust for Measurement (CRTM) that is invoked after system reset. In one embodiment, the CRTM code is stored in a boot block. The Trusted Computing Group requires that the CRTM be immutable (i.e., changeable by the ACP 102 manufacturer under controlled conditions). In one embodiment, the CRTM logic may be the first instructions to execute in CPU 104 after ACP 102 is reset. In another embodiment, the CRTM logic may execute in platform component prior to CPU's execution of any instructions. The CRTM computes integrity measurements on the next code to execute in the boot sequence and stores the measurements in platform configuration registers (PCRs) within the TPM. Exemplary integrity measurement algorithms include Secure Hash Algorithm 1 (SHA-1), other one-way hash algorithms, symmetric cryptographic algorithms, asymmetric cryptographic algorithms, etc. Control transfers to the next code in the boot sequence, which measures the next code to be loaded in the boot chain and stores the measurements in the TPM's PCRs. This “chain of trust” process continues until all the TBCB software is loaded and a complete set of measurements for the TBCB is stored in TPM's PCRs. TBCB is assumed to execute in CPU at the highest privilege levels, such that any other code running in CPU cannot corrupt TBCB's code or data structures. On more complex platforms, the boot, integrity measurement computation, and measurement recording process may be more complex, and utilize multiple TPMs. In one embodiment, those components in the boot chain performing the integrity measurements also maintain a measurement log. The measurement log includes descriptions of the integrity measurements, including what code was measured in what order, and the location (platform configuration register) where each measurement is stored within the TPM. The measurement log may be stored in memory or any suitable storage medium accessible by the ACP.

Once the TBCB code has been loaded and measured, with measurements stored in the TPM, the protected storage capabilities of the TPM be used to encrypt (i.e., seal) cryptographic keys for TBCB using the values stored in TPM's PCRs that contain the integrity measurements of TBCB and a unique value protected in TPM. Such keys can be used for secure communications with entities external to ACP such as hardware component.

### II. Performing Secure Communications Between an ACP and a Hardware Component

After TBCB has been booted on CPU and the integrity measurements have been taken and recorded in TPM, a secure communication path may be established between the ACP and a hardware component. The secure communication path provides source authentication and optional integrity and secrecy, to protect sensitive information transferred between the ACP and the hardware component. Examples of sensitive information requiring protection include partition identifiers, domain identifiers, zone identifiers, container identifiers, mandatory access control security labels, locality identifiers, cryptographic keys, and critical security parameters.

The secure communication path authenticates to the hardware component that the source of communication is the CPU executing TBCB (CETBCB). Vice versa, the secured communication path may also authenticate the hardware component as the source of information transmitted to the ACP. Two embodiments for providing a secure communication path between the ACP and the hardware component are a basic secure communication path and a high performance secure communication path. Both the basic and high performance secure communication path use cryptographic methods for source authentication, integrity, and secrecy. These are described below.

Basic Secure Communication Path

A secure communication path is first established before the secure communication path can be used to protect the data transmitted. Establishing a secure communication path includes the generation, provision, distribution and registration of cryptographic keys, as described below.

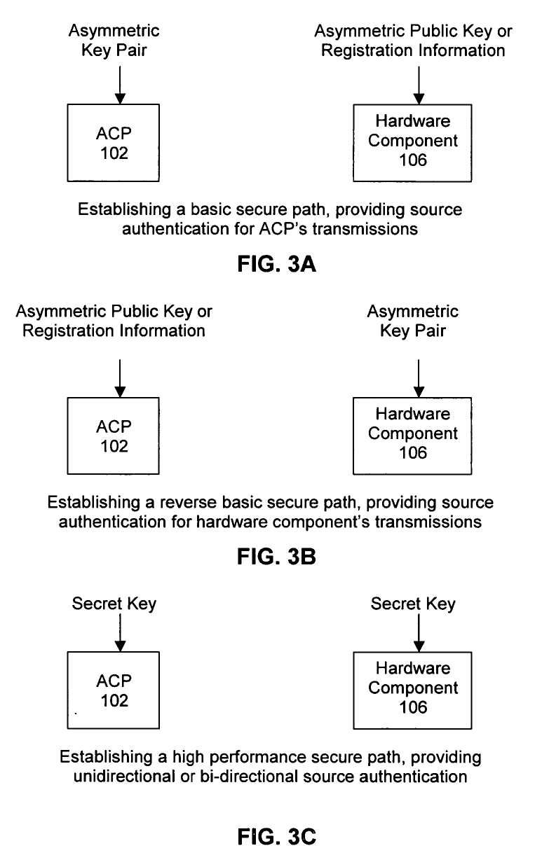

FIGS. 3A, 3B, and 3C are simplified schematic diagrams of methods for establishing a basic secure communication path and a high performance secure communication path, in accordance with one embodiment of the present invention. FIG. 3A depicts a method for establishing a basic secure communication path. In the basic secure communication path, asymmetric cryptography is used to authenticate the sender, which digitally signs its transmissions using an asymmetric private key as input to an asymmetric cryptographic algorithm. Asymmetric cryptographic algorithms include Rivest-Shamir-Adelman (RSA), Digital Signature Algorithm (DSA), Diffie-Hellman, and Elliptical Curve. The sender's digital signature may be validated by the receiver. In order to do so, the sender's asymmetric public key may be registered with the receiver, as described below. In FIG. 3A, the sender is ACP 102 and the receiver is hardware component 106, and the secure communication path being established is the basic secure communication path. An asymmetric key pair is generated within ACP 102, or provided to ACP 102 over a secure administrative path. Either the asymmetric public key of this key pair is provided to the hardware component 106 over a secure administrative path, or registration information for the asymmetric public key is provided to the hardware component over a secure administrative path.

In FIG. 3B, the sender is hardware component 106 and the receiver is ACP 102, and the secure communication path being established is the reverse basic secure communication path. An asymmetric key pair is generated within hardware component 106, or provided to the hardware component over a secure administrative path. Either the asymmetric public key of this key pair is provided to ACP 102 over a secure administrative path, or registration information for the asymmetric public key is provided to the ACP over a secure administrative path.

In FIG. 3C, either party may be the sender, and the secure communication path being established is the high performance secure communication path (described below). A secret key may be provided to both parties over secure administrative paths to each, and the high performance secure communication path provides bi-directional authentication. Alternatively, a key exchange between the parties may be used to distribute the secret key, and the secure communication path may provide either unidirectional source authentication or bi-directional source authentication, depending on the method used for the key exchange, as described below.

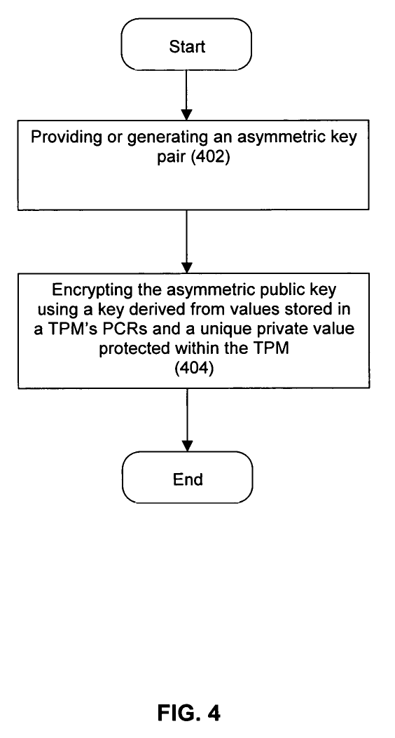

FIG. 4 is a flowchart diagram of a high level overview of a method for providing a basic secure communication path, in accordance with one embodiment of the present invention. Starting in operation 402, an asymmetric key pair is either generated within a party, or provided to the party over a secure administrative path. The asymmetric key pair is comprised of an asymmetric public key and an asymmetric private key. In one embodiment, the asymmetric key pair is provided to the ACP through a secure administrative path. In another embodiment, the TBCB in the ACP generates the asymmetric key pair. In still another embodiment, the TBCB commands the TPM to generate the asymmetric key pair.

In operation 404, the asymmetric private key is stored within the TPM and encrypted (i.e., sealed) by the TPM using a key derived from the integrity measurements for the TBCB and a unique private value protected in the TPM's memory. For example, in one embodiment, the integrity measurements of the TBCB used for deriving the key are contained in the platform configuration registers of the TPM. Subsequently, as will be explained in more detail below, the ACP's asymmetric public key is registered with the hardware component. The asymmetric private key is encrypted by the TPM using a key derived from the integrity measurements for TBCB to ensure that the correct TBCB can access the key. As a result, the encrypted asymmetric private key may be decrypted (i.e., unsealed) by the TPM if the same integrity measurements are taken after a subsequent computer boot. In other words, if the program code being loaded for execution has been modified after a subsequent computer boot, the integrity measurements would be different, and the integrity measurements associated with the modified program code cannot be used to decrypt the asymmetric private key. After the asymmetric private key has been decrypted, the asymmetric private key may be used to encrypt data (or a hash of the data) transmitted from the ACP to the hardware component, and to decrypt data transmitted from the hardware component to the ACP that has been encrypted using the ACP's asymmetric public key.

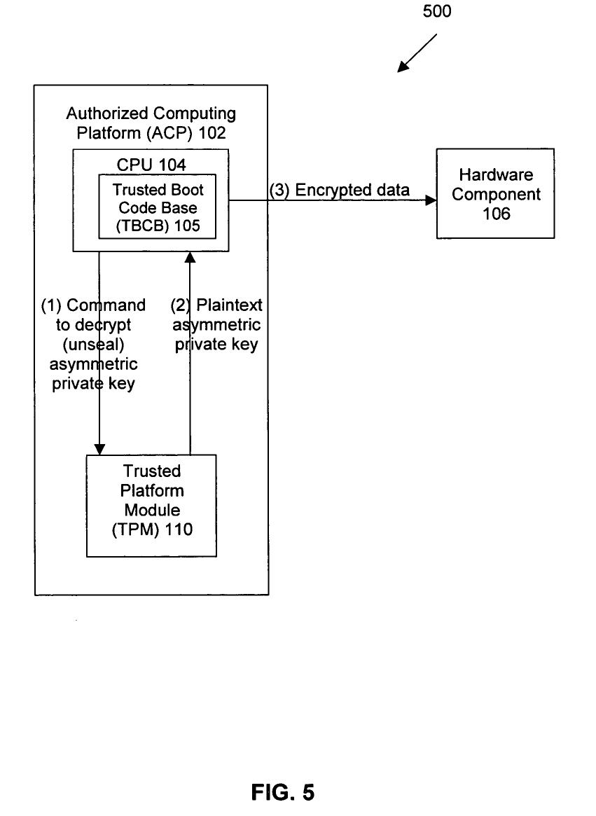

FIG. 5 is a simplified block diagram of a more detailed overview for providing a basic secure communication path, in accordance with one embodiment of the present invention. As shown in FIG. 5, computer system 500 includes ACP 102 and hardware component 106. ACP 102 includes CPU 104 and TPM 110. TBCB 105 executes within CPU 104. As discussed above, in one embodiment, an asymmetric key pair is provided to TBCB 105 running on CPU 104 through a secure administrative path. In another embodiment, TBCB 105 generates the asymmetric key pair. In still another embodiment, the asymmetric key pair is generated in TPM 110.

The asymmetric public key may be registered with hardware component 106 via one of several methods. In one embodiment, the asymmetric public key is registered using the public key method. With the public key method, the asymmetric public key can enter into hardware component 106 either through a secure administrative path to the hardware component, or by having TBCB 105 send the asymmetric public key to the hardware component when the hardware component is in a special configuration state. Hardware component 106 may then use the asymmetric public key to decrypt or verify data transmitted from TBCB 105 that has been encrypted or signed using the associated asymmetric private key. When the public key method is used, the hardware component's validation of the asymmetric public key prior to using the asymmetric public key consists simply of retrieving the asymmetric public key from the memory of the hardware component and insuring that the asymmetric public key has not been corrupted, through typical memory integrity techniques such as Error Correction Code Memory, a Cyclic Redundancy Check, one-way hash computation on the asymmetric public key, etc.

In another embodiment, the asymmetric public key is registered with hardware component 106 using the fingerprint method. With the fingerprint method, a fingerprint value derived from the asymmetric public key may be registered with hardware component 106 through a secure administrative path to the hardware component.

In still another embodiment, the asymmetric public key is registered with hardware component 106 using the digital certificate method. In this embodiment, a certificate authority (CA) digitally signs the asymmetric public key along with a unique identifying name (or signs a hash of the asymmetric public key and the unique identifying name). The CA's public key associated with the signing key and the unique identifying name is entered into hardware component 106 via a secure administrative path to the hardware component.

After the asymmetric key pair is generated or provided, TBCB 105 commands TPM 110 to encrypt the associated asymmetric private key using a key derived from the integrity measurements for TBCB 105 and a unique private value protected in TPM 110's memory, in accordance with one embodiment of the present invention. After the asymmetric private key has been encrypted and stored in TPM 110, TBCB 105 may retrieve the asymmetric private key for later use when encrypting data transmitted to hardware component 106.

Subsequently, whenever TBCB 105 transmits data to hardware component 106, the TBCB first commands TPM 110 to decrypt the asymmetric private key using a key derived from the integrity measurements for the TBCB and a unique private value protected in TPM's memory. Decryption using the integrity measurements will fail if software different from TBCB 105 with different integrity measurements has been booted.

In one embodiment, TBCB 105 then commands TPM 110 to encrypt the data (or a hash of the data) to be transmitted to hardware component 106 using the decrypted asymmetric private key. In another embodiment, TBCB 105 itself can encrypt the data (or a hash of the data) using the asymmetric private key retrieved from TPM 110. Using the pre-registered asymmetric public key, hardware component 106 can decrypt the data (or a hash of the data) using the asymmetric public key associated with the asymmetric private key, and thereby be assured that TBCB 105 sent the data. For example, using the public key method, the asymmetric public key has been pre-entered into hardware component 106 and can be used to decrypt the data (or a hash of the data) sent by TBCB 105. Alternatively, using the fingerprint method, the asymmetric public key may be sent to hardware component 106, along with data being transmitted, and the hardware component can validate the asymmetric public key using the stored fingerprint values. Hardware component 106 then uses the validated asymmetric public key to decrypt the transmitted data (or a hash of the data). With the digital certificate method, TBCB 105 sends a certificate containing the asymmetric public key and unique identifying name, signed by a CA, to hardware component 106 along with the data being transmitted. Hardware component 106 uses the CA's public key, which was previously entered into the hardware component through a secure administrative path, to validate the asymmetric public key and unique identifying name, and matches the unique identifying name in the certificate with the expected name. The validated asymmetric public key may then be used to decrypt the transmitted data (or a hash of the data) from TBCB 105.

In another embodiment, a reverse basic secure communication path may also be set up to provide source authentication, integrity, and optional secrecy in the opposite direction for communications from hardware component 106 to TBCB 105. Essentially, to provide a reverse secure communication, the above-described method is reversed. Here, in one embodiment, hardware component 106 creates an asymmetric key pair, and the associated asymmetric public key is registered with TBCB 105 using either the public key method, fingerprint method, or the digital certificate method. The registration information for the asymmetric public key may optionally be stored in TPM 110 and encrypted using a key derived from the integrity measurements for TBCB 105. Hardware component 106 then uses the asymmetric private key to encrypt data (or a hash of the data) transmitted to TBCB 105. Using the registration information, TBCB 105 may validate the asymmetric public key and use the validated asymmetric public key to decrypt data (or a hash of the data) transmitted by hardware component 106.

With the above-described basic secure communication path method for securing communication between TBCB 105 and hardware component 106, the hardware component can be assured that the data was transmitted by the TBCB, and not by unauthorized software running in CPU 104. If the TBCB program code is modified, a trusted administrator, over a secure administrative path may command a new asymmetric key pair to be created in TPM 110 and encrypted using integrity measurements for the new TBCB. The trusted administrator registers the new asymmetric public key with hardware component 106. Alternatively, the trusted administrator may command that the asymmetric private key be migrated to the new TBCB software configuration, causing the asymmetric private key to be encrypted in the integrity measurements of the new TBCB rather than the integrity measurements of the original TBCB 105.

High Performance Secure Communication Path

To improve performance, a high performance secure communication path may be additionally provided to transfer security critical information between the ACP and the hardware component. In contrast to the above described basic secure communication path that is based on asymmetric cryptography, the security mechanism for this high performance secure communication path is based on symmetric cryptography and/or a one-way hash algorithm. Communication based on symmetric cryptography is typically less computation intensive than communication based on asymmetric cryptography. As will be explained in more detail below, symmetric cryptography provides secrecy on the communication path between the ACP and the hardware component, and the one-way hash algorithm provides integrity and source authentication.

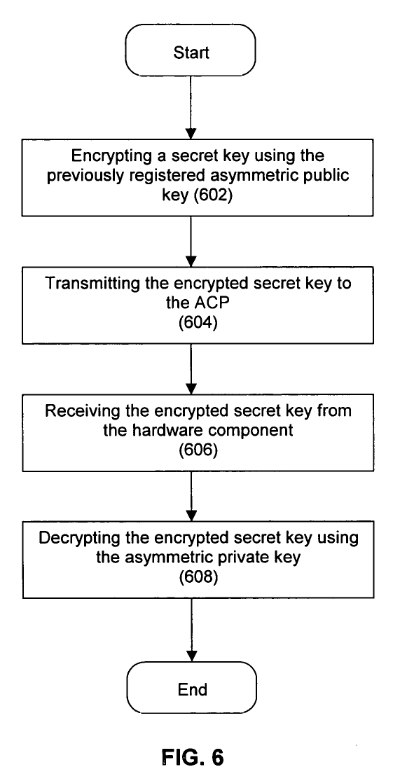

FIG. 6 is a flowchart diagram of a high level overview of a method for providing a high performance secure communication path, in accordance with one embodiment of the present invention. To provide a high performance secure communication path, a secret key is shared between the hardware component and the ACP. In one embodiment, the secret key may be distributed to the ACP and the hardware component through secure administrative paths to each of the ACP and hardware component. In another embodiment, the secret key may be distributed using the above described basic secure communication path. For example, the ACP's asymmetric public key has been pre-registered with the hardware component using one of the methods described above. With the fingerprint or certificate method, the ACP sends the asymmetric public key to the hardware component to start the key exchange. With the public key method, the hardware component already has the ACP's asymmetric public key, such that a simple start message is all that is needed to start the key exchange.

Subsequently, the hardware component validates the asymmetric public key and then generates a secret key. As shown in FIG. 6, the hardware component then encrypts the secret key using the ACP's asymmetric public key in operation 602. After encryption, the hardware component transmits the encrypted secret key to the ACP in operation 604. The ACP then receives the encrypted secret key in operation 606. As discussed above, the TBCB executing in the CPU can command the TPM to decrypt (i.e., unseal) the asymmetric private key that is encrypted (i.e., sealed) in the TPM using a key derived from integrity measurements for the TBCB and a unique private value protected in the TPM's memory. Accordingly, in operation 608, the TBCB uses the asymmetric private key to decrypt the secret key. As a result, the secret key is known to both the TBCB and hardware component.

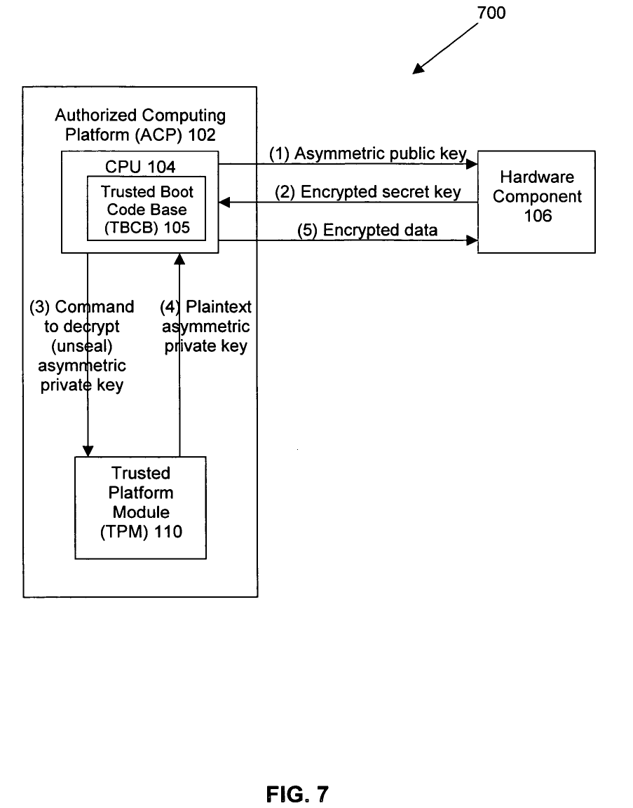

FIG. 7 is a simplified block diagram of a more detailed overview for providing a high performance secure communication path, in accordance with one embodiment of the present invention. As shown in FIG. 7, computer system 700 includes ACP 102 and hardware component 106. ACP 102 includes CPU 104 and TPM 110. TBCB 105 executes on CPU 104. ACP 102 brings up TBCB 105 and computes integrity measurements on TBCB 105, storing these measurements in TPM 110. The basic secure communication path is established as described above. A secret key is generated in hardware component 106, either using the hardware component's random number generator or from an external key generation source securely connected to hardware component 106. ACP 102 has previously registered its asymmetric public key with hardware component 106, and commanded TPM 110 to encrypt the asymmetric private key as described above for the basic secure communication path. With the fingerprint or certificate registration method, TBCB 105 sends the asymmetric public key to hardware component 106 to start the key exchange, and the hardware component validates the received asymmetric public key using the registration information. With the public key method, the asymmetric public key was entered into hardware component 106 via a secure administrative path, and a simple start message is used to start the key exchange.

Hardware component 106 then uses the asymmetric public key to encrypt the secret key and transmits the encrypted secret key to TBCB 105. After receiving the encrypted secret key, TBCB 105 commands TPM 110 to decrypt (i.e., unseal) the asymmetric private key, using a key derived from the integrity measurements for the TBCB and a unique private value in the TPM. Thereafter, ACP 102 decrypts the secret key using the decrypted asymmetric private key. In one embodiment, TBCB 105 decrypts the secret key. In another embodiment, TPM 110 decrypts the secret key.

The key exchange may be reversed utilizing the reverse basic secure communication path. ACP 102 may either generate a secret key, or receive a secret key over a secure administrative path. ACP 102 encrypts the secret key using a previously registered asymmetric public key of hardware component 106 and sends the encrypted secret key to the hardware component. Hardware component 106 may use its asymmetric private key to decrypt the secret key.

In another embodiment, the key exchange with bi-directional authentication may also be reversed with TBCB 105 or TPM 110 generating the secret key and the TBCB sending the generated secret key to hardware component 106, encrypted using the hardware component's asymmetric public key. Bi-directional authentication may be performed by having hardware component 106 send a nonce to TBCB 105 in the first part of the key exchange, and the TBCB signs the nonce and the generated secret key using the asymmetric private key. TBCB 105 transmits the signed nonce and encrypted secret key to hardware component 106. When the fingerprint method is used, TBCB 105 sends its asymmetric public key that has previously been registered with hardware component 106. When the digital certificate method is used, TBCB 105 sends its digital certificate containing its asymmetric public key and unique identifying name, the asymmetric public key of the CA that signed the digital certificate and the unique identifying name having been previously registered with hardware component 106. Hardware component 106 validates the received public key or digital certificate using the registration information. Hardware component 106 then validates the signature using the validated asymmetric public key and decrypts the secret key using the asymmetric private key.

In another exemplary embodiment, a Diffie-Hellman exchange between hardware component 106 and TBCB 105 may be used with optional bi-directional authentication. As is known to those skilled in the art, the Diffie-Hellman protocol allows two users to exchange a secret key over an insecure medium without prior secrets. Here, for bi-directional authentication, both hardware component 106 and TBCB 105 generate an asymmetric public and private key pair, and the hardware component and the TBCB both register their asymmetric public key with each other through a secure administrative path. Subsequently, each party generates a Diffie-Hellman public/private key pair and, for bi-directional authentication, signs the public key and a value known to the other party with their previously generated asymmetric private key and transmits the asymmetric private key to the other party. The receiving party validates the signature and uses the received Diffie-Hellman public key and its Diffie-Hellman private key to compute the secret key, according to the Diffie-Hellman algorithm.

When source authentication of the key exchange messages between ACP 102 and hardware component 106 is required, a sender may digitally sign its transmission using its asymmetric private key as input to an asymmetric cryptographic algorithm. The signed message should be unique to the exchange to prevent replay attacks. Verification of the signature by the receiver is performed using a pre-registered asymmetric public key. Source authentication in the key exchange may be unidirectional or bidirectional. Authentication of a source of a key exchange message in turn authenticates that source in the high performance secure communication path.

For example, in one embodiment, a reverse basic secure communication path as described above is first provided. As part of the secret key exchange, hardware component 106 signs, using its asymmetric private key, a nonce transmitted by TBCB 105 to hardware component 106 in the first part of the secret key exchange. The nonce is defined as a unique, numeric value for the key exchange. This signature also covers the encrypted secret key generated and sent by hardware component 106. When the fingerprint or digital certificate method is used, hardware component 106 also transmits to TBCB 10S its asymmetric public key that has been previously registered, and the TBCB validates that asymmetric public key using registration information previously provided. TBCB 105 then validates the signature using the asymmetric public key of hardware component 106, and decrypts the secret key using its asymmetric private key. If validation succeeds, then TBCB 105 knows that hardware component 106 sent the secret key.

The secret key may be stored in a memory accessible to CPU 104 or in TPM 110. When stored in TPM 110, the secret key may be encrypted by the TPM using a key derived from the integrity measurements for TBCB 105 and a unique private value in the TPM, in accordance with one embodiment of the present invention. In another embodiment, the secret key may also be stored in a secure key store within hardware component 106. When stored in TPM 110 and hardware component 106, the secret key may also be used across multiple platform boots. The retention of the secret key in this manner obviates the need to exchange keys for the high performance secure communication path for each computer boot. Additionally, the secret key that is encrypted using a key derived from integrity measurements needs to be migrated as discussed above whenever TBCB 105 is updated.

In sum, the high performance secure communication path relies on secret keys for source authentication, integrity, and secrecy of security critical information transferred between the TBCB and the hardware component. To protect communications, a symmetric cryptographic algorithm and/or a one-way hash algorithm may be used. The symmetric cryptographic algorithm provides secrecy while the one-way hash algorithm provides integrity and source authentication.

To provide secrecy, the exchanged secret key or another secret key derived from the exchanged secret key using an algorithm known to both the ACP and the hardware component, is used for encrypting the data transmitted between the ACP and the hardware component. The encryption may be done in addition to the one-way hash computation. Either the symmetric algorithm may be performed first and followed by the one-way hash using the encrypted data as input, or the one-way hash computation may be done first, followed by encrypting the data, nonce, and digest. The receiver uses the secret key to decrypt the data and validate the hash result. It should be appreciated that the secret key used for encryption may be different from the key used in the one-way hash computation.

To provide source authentication and integrity, a sender computes a one-way hash algorithm over the data being transmitted and over a secret key or over a key derived from the secret key using an algorithm known to both the TBCB and the hardware component. As discussed above, to prevent replays, the sender also includes a nonce as input to the one way hash algorithm. The nonce may be generated in the receiver (and transmitted to the sender), or generated in the sender (and transmitted to the receiver). The one-way hash computation result, known as a digest, is sent with the data, but the secret key is not sent. The receiver performs the same computation and compares the computation with the received digest. If the computation and the received digest matches, the sender is authenticated and the integrity of the received information is assured. The receiver also validates the uniqueness of the nonce or whether the nonce matches to what was supplied by the receiver if the receiver has supplied the nonce.

As stated above, the one-way hash method can be used alone or in combination with the symmetric cryptographic method. The symmetric cryptographic method may also be used alone, as well as in combination with the one-way hash method. When combined, the methods may be applied in either order: either the one-way hash method encapsulating (applied after) the symmetric cryptographic method, or the symmetric cryptographic method encapsulating the one-way hash method. The one-way hash method may also encapsulate the asymmetric cryptographic method of the basic secure communication path, or vice versa.

It will be apparent to one skilled in the art that the functionality described herein may be synthesized into firmware through a suitable hardware description language (HDL). For example, the HDL (e.g., VERILOG) may be employed to synthesize the firmware and the layout of the logic gates for providing the necessary functionality described herein to provide hardware implementations of providing a secure communication and of the computer boot securing techniques and associated functionalities. Thus, the embodiments described herein may be captured in any suitable form or format that accomplishes the functionality described herein and is not limited to a particular form or format.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware-based method for performing secure communications between an authorized computing platform (ACP) and a hardware component, comprising method operations of:
establishing a secure communication path between the ACP and the hardware component; and
protecting data transmitted over the secure communication path between the ACP and the hardware component.

2. The hardware-based method of claim 1, wherein the ACP includes,
a central processing unit (CPU);
a trusted boot code base (TBCB) executing on the CPU; and
a trusted platform module (TPM).

3. The hardware-based method of claim 1, further comprising:
generating an asymmetric key pair, the asymmetric key pair comprising a first asymmetric public key and an asymmetric private key.

4. The hardware-based method of claim 1, wherein the method operation of establishing the secure communication path between the ACP and the hardware component includes,
registering asymmetric public keys.

5. The hardware-based method of claim 4, wherein the method operation of registering the asymmetric public keys includes,
if a public key method is used, providing a first asymmetric public key through a secure administrative path;
if a digital certificate method is used, providing a second asymmetric public key of a certificate authority used to sign the first asymmetric public key through the secure administrative path; and
if a fingerprint method is used, providing a fingerprint value of the first asymmetric public key through the secure administrative path.

6. The hardware-based method of claim 4, wherein the method operation of registering the asymmetric public keys include,
if a digital certificate method is used, including a second digital certificate with transmissions that are signed using an asymmetric private key, second digital certificate including a first asymmetric public key and second identifying information signed by a certificate authority; and
if a fingerprint method is used, including a third asymmetric public key with transmissions that are signed using an asymmetric private key.

7. The hardware-based method of claim 1, wherein the method of operation of establishing the secure communication path between the hardware component and the ACP includes,
providing a secret key to the hardware component through a first secure administrative path; and
providing the secret key to the ACP through a second secure administrative path,
wherein the secure communication path uses one of a symmetric cryptography method and a one-way hash method.

8. The hardware-based method of claim 1, wherein the method operation of establishing the secure communication path between the hardware component and the ACP includes,
performing a secret key exchange between the hardware component and the ACP,
wherein the secure communication path uses one of a symmetric cryptography method and a one-way hash method.

9. The hardware-based method of claim 8, wherein the method operation of performing the secret key exchange includes,
generating a secret key;
storing the secret key;
encrypting the secret key using an asymmetric public key; and
transmitting the encrypted secret key.

10. The hardware-based method of claim 8, wherein the method operation of performing the secret key exchange includes:
receiving an encrypted secret key;
decrypting the encrypted secret key using an asymmetric private key; and
storing the decrypted secret key.

11. The hardware-based method of claim 8, wherein the method operation of performing the secret key exchange includes,
generating a first Diffie-Hellman key pair, the first Diffie-Hellman key pair including a first Diffie-Hellman public key and a first Diffie-Hellman private key;
receiving a second Diffie-Hellman key pair, the second Diffie-Hellman key pair including a second Diffie-Hellman public key and a second Diffie-Hellman private key;
generating a secret key from the first and second Diffie-Hellman private keys according to a Diffie-Hellman algorithm; and
storing the secret key.

12. The hardware-based method of claim 8, wherein the method operation of performing the secret key exchange includes,
signing a transmission using an asymmetric private key.

13. The hardware-based method of claim 8, wherein the method operation of performing the secret key exchange includes,
verifying a received signature using a first asymmetric public key.

14. The hardware-based method of claim 13, wherein the method of operation of verifying the received signature includes,
verifying a signature of a certificate authority over a second digital certificate using a second asymmetric public key as input to an asymmetric cryptographic operation; and
checking for a match between second identifying information and first identifying information,
wherein registration of an asymmetric public key uses a digital certificate method.

15. The hardware-based method of claim 13, wherein the method of operation of verifying the received signature includes,
verifying that a fingerprint of a third asymmetric public key matches a fingerprint of a first asymmetric public key,
wherein registration of an asymmetric public key uses a fingerprint method.

16. The method of claim 1, wherein the method of operation of protecting the data transmitted over the secure communication path includes,
encrypting the data prior to transmission with an asymmetric cryptographic algorithm using a first asymmetric private key as input; and
transmitting the encrypted data,
wherein protecting the data transmitted uses an asymmetric cryptography method.

17. The method of claim 1, wherein the method of operation of protecting the data transmitted between over the secure communication path includes:
encrypting the data prior to transmission with a symmetric cryptographic algorithm using a secret key as an input; and
transmitting the encrypted data,
wherein protecting the data transmitted uses a symmetric cryptography method.

18. The method of claim 1, wherein the method of operation of protecting the data transmitted over the communication path includes,
computing a one-way hash over the data and a secret key, a result of the computation being a first digest; and
transmitting the data and the first digest,
wherein protecting the data transmitted uses a one-way hash method.

19. The method of claim 1, wherein the method of operation of protecting the data transmitted over the secure communication path includes,
computing a one-way hash over the data to be transmitted, an output of the computation being a first digest;
encrypting the first digest with an asymmetric cryptographic algorithm using an asymmetric private key as an input; and
transmitting the data and the encrypted first digest,
wherein protecting the data transmitted uses an asymmetric cryptography method encapsulating a one-way hash method.

20. The method of claim 1, wherein the method of operation of protecting the data transmitted over the secure communication path includes,
encrypting the data prior to transmission with an asymmetric cryptographic algorithm using an asymmetric private key as an input;
computing a one-way hash over the encrypted data and a secret key, a result of the computation being a first digest that is transmitted with the data; and
transmitting the encrypted data and the first digest,
wherein protecting the data transmitted uses a one-way hash method encapsulating an asymmetric cryptography method.

21. The method of claim 1, wherein the method of operation of protecting the data transmitted over the secure communication path includes,
computing a one-way hash over the data to be transmitted and a secret key, a result of the computation being a first digest;
encrypting the data and first digest with a symmetric cryptographic algorithm using a secret key as input; and
transmitting the encrypted data and the encrypted first digest,
wherein protecting the data transmitted uses a symmetric cryptography method encapsulating a one-way hash method.

22. The method of claim 1, wherein the method of operation of protecting the data transmitted over the secure communication path includes,
encrypting the data prior to transmission with a symmetric cryptographic algorithm using a secret key as input;
computing a one-way hash over the encrypted data and the secret key, a result of the computation being a first digest that is transmitted with the data; and
transmitting the encrypted data and the first digest,
wherein protecting the data transmitted uses a one-way hash method encapsulating a symmetric cryptography method.

23. The method of claim 1, wherein the method of operation of protecting the data transmitted over the secure communication path includes,
receiving protected transmitted data; and
decrypting the protected transmitted data using an asymmetric public key as input to an asymmetric cryptographic algorithm,
wherein protecting the data transmitted uses an asymmetric cryptography method.

24. The method of claim 1, wherein the method of operation of protecting the data transmitted over the secure communication path includes,
receiving protected transmitted data; and
decrypting the protected transmitted data using a secret key as input to a symmetric cryptographic algorithm,
wherein protecting the data transmitted uses a symmetric cryptography method.

25. The method of claim 1, wherein the method of operation of protecting the data transmitted over the secure communication path includes,
receiving protected transmitted data and a first digest;
computing a second digest over the protected transmitted data and a secret key; and
validating that a second digest matches the first digest,
wherein protecting the data transmitted uses a one-way hash method.

26. The method of claim 1, wherein the method of operation of protecting the data transmitted over the secure communication path includes,
receiving protected transmitted data and an encrypted first digest;
computing a one-way hash over the protected transmitted data, an output of the computation being a second digest;
decrypting the encrypted first digest using a first asymmetric public key as input to an asymmetric cryptographic algorithm; and
validating that the first digest matches the second digest,
wherein protecting the data transmitted uses an asymmetric cryptography method encapsulating a one-way hash method.

27. The method of claim 1, wherein the method of operation of protecting the data transmitted over the secure communication path includes,
receiving protected transmitted data and a first digest;
computing a second digest over the protected transmitted data and a secret key;
validating that the second digest matches the first digest; and
decrypting the protected transmitted data with an asymmetric cryptographic algorithm using a first asymmetric public key as input,
wherein protecting the data transmitted uses a one-way hash method encapsulating an asymmetric cryptographic method.

28. The method of claim 1, wherein the method of operation of protecting the data transmitted over the secure communication path includes,
receiving protected transmitted data and a first digest;
decrypting the protected transmitted data and the first digest using a secret key as input to a symmetric cryptographic algorithm;
computing a second digest over the protected transmitted data and the secret key; and
validating that the second digest matches the first digest,
wherein protecting the data transmitted uses a symmetric cryptography method encapsulating a one-way hash method.

29. The method of claim 1, wherein the method of operation of protecting the data transmitted between an ACP and a hardware component includes,
receiving protected transmitted data and a first digest;
computing a second digest over the protected transmitted data and a secret key; and
validating that the second digest matches the first digest; and
decrypting the protected transmitted data with a symmetric cryptographic algorithm using the secret key as input,
wherein protecting the data transmitted uses a one-way hash method encapsulating a symmetric cryptographic method.

30. The hardware-based method of claim 1, wherein the method operation of protecting the data transmitted over the secure communication path includes,
if a digital certificate method is used, transmitting a second digital certificate including an asymmetric public key and a second identifying information;
if a fingerprint method is used, transmitting a third asymmetric public key,
wherein protecting the data transmitted uses an asymmetric cryptography method.

31. The hardware-based method of claim 1, wherein the method operation of protecting the data transmitted over the secure communication path includes,
verifying a signature of a certificate authority over a second digital certificate using a second asymmetric public key as input to an asymmetric cryptographic operation; and
checking for a match between second identifying information and first identifying information,
wherein a registration of an asymmetric public key uses the digital certificate method.

32. The hardware-based method of claim 1, wherein protecting the data transmitted over the secure communication path includes,
verifying that a fingerprint of a third asymmetric public key matches a fingerprint of a first asymmetric public key,
wherein a registration of an asymmetric public key uses the fingerprint method.

33. The hardware-based method of claim 1, further comprising:
calculating first integrity measurements during a first computer boot;
storing the first integrity measurements in a trusted platform module (TPM);
encrypting an asymmetric private key using a first key derived from first integrity measurements and a unique private value protected in a memory of the TPM, the first integrity measurements being measurements of a trusted boot code base (TBCB) loaded for execution during the first computer boot,
wherein protecting the data transmitted uses an asymmetric cryptography method.

34. The hardware-based method of claim 1, further comprising:
calculating second integrity measurements during a second computer boot;
storing the second integrity measurements in a trusted platform module (TPM);
decrypting an asymmetric private key using a second key derived from the second integrity measurements and a unique private value protected in a memory of the TPM, the second integrity measurements being measurements of program code loaded for execution during a second computer boot,
wherein protecting the data transmitted uses an asymmetric cryptography method.

35. The hardware-based method of claim 34, wherein the method operation of decrypting the encrypted asymmetric private key includes,
if the second integrity measurements match the first integrity measurements, yielding the asymmetric private key.

36. The hardware-based method of claim 1, further comprising:
calculating first integrity measurements during a first computer boot;
storing the first integrity measurements in a trusted platform module (TPM); and
encrypting a secret key using a first key derived from first integrity measurements and a unique private value protected in a memory of the TPM, the first integrity measurements being measurements of a trusted boot code base (TBCB) loaded for execution during a first computer boot,
wherein protecting the data transmitted uses one of a symmetric cryptography method and a one-way hash method.

37. The hardware-based method of claim 1, further comprising:
calculating second integrity measurements during a second computer boot;
storing the second integrity measurements in a trusted platform module (TPM); and
decrypting a secret key using a second key derived from the second integrity measurements and a unique private value protected in a memory of the TPM, the second integrity measurements being measurements of program code loaded for execution during a second computer boot,
wherein protecting the data transmitted uses one of a symmetric cryptography method and a one-way hash method.

38. The hardware-based method of claim 37, wherein the method operation of decrypting the secret key includes,
if the second integrity measurements match the first integrity measurements, yielding the secret key.

39. The hardware-based method of claim 33, wherein the first key is derived from values in platform configuration registers of the TPM containing the first integrity measurements.

40. The hardware-based method of claim 37, wherein the second key derived is derived from values in platform configuration registers of the TPM containing the second integrity measurements.

41. An authorized computing platform (ACP) for securely communicating with a hardware component, comprising:
logic for establishing a secure communication path with the hardware component; and
logic for protecting data transmitted over the secure communication path with the hardware component.

42. The ACP of claim 41, further comprising:
a central processing unit (CPU) executing a trusted boot code base (CETBCB), the CETBCB including,
logic for establishing the secure communication path with the hardware component,
logic for utilizing a trusted platform module (TPM) to protect private and secret keys associated with the secure communication path with the hardware component, and
logic for protecting data transmitted over the secure communication path with the hardware component; and
the TPM in communication with the CPU, the TPM including,
logic for protecting private and secret keys used for the secure communication path with the hardware component.

43. The ACP of claim 41, further comprising:
logic for protecting the TBCB from corruption by components external to the TBCB.

44. The ACP of claim 42, wherein the logic for establishing the secure communication path with the hardware component includes,
logic for generating an asymmetric key pair;
logic for receiving an asymmetric private key over a secure administrative path;
logic for receiving asymmetric public key registration information over the secure administrative path;
logic for receiving the asymmetric public key;
logic for generating a secret key;
logic for receiving the secret key over the secure administrative path;
logic for performing a secret key exchange;
logic for signing secret key exchange messages using an asymmetric private key; and
logic for validating a signed secret key exchange message using the asymmetric public key.

45. The ACP of claim 44, wherein the logic for performing the secret key exchange includes,
logic for receiving the asymmetric public key; and
logic for validating the asymmetric public key using the asymmetric public key registration information.

46. The ACP of claim 42, wherein the logic for utilizing a TPM to protect private and secret keys associated with a secure communication path with a hardware component includes,
logic for calculating first integrity measurements during a first computer boot, the first integrity measurements being measurements of TBCB loaded for execution during a first computer boot;
logic for storing first integrity measurements in the TPM;
logic for commanding the TPM to encrypt an asymmetric private key using first key derived from first integrity measurements and unique values protected in the TPM's memory;
logic for commanding the TPM to encrypt a secret key using first key derived from first integrity measurements and unique values protected in the TPM's memory;
logic for calculating second integrity measurements during a second computer boot, the second integrity measurements being measurements of program code loaded for execution during a second computer boot;
logic for storing second integrity measurements in the TPM;
logic for commanding the TPM to decrypt an asymmetric private key using a second key derived from the second integrity measurements and a unique private value protected in the TPM's memory; and
logic for commanding the TPM to decrypt a secret key using a second key derived from the second integrity measurements and a unique private value protected in the TPM's memory.

47. The ACP of claim 42, wherein the logic for protecting data transmitted over a secure communication path with the hardware component includes,
logic for encrypting data prior to transmission with an asymmetric cryptographic algorithm using an asymmetric private key as input;
logic for encrypting data prior to transmission with a symmetric cryptographic algorithm using a secret key as input;
logic for computing a one-way hash over a secret key and data to be transmitted, the result of the one-way hash computation being a first digest that is transmitted with the data;
logic for encrypting data prior to transmission with an asymmetric cryptographic algorithm using an asymmetric private key as input, then computing a one-way hash over the encrypted data and a secret key, the result of the one-way hash computation being a first digest that is transmitted with the data;
logic for computing a one-way hash over data to be transmitted, the result being a first digest, then encrypting the first digest with an asymmetric algorithm using an asymmetric private key as input;
logic for encrypting data prior to transmission with a symmetric cryptographic algorithm using a secret key as input, then computing a one-way hash over the encrypted data and a secret key, the result being a first digest transmitted with the encrypted data;
logic for computing a one-way hash over a secret key and data prior to transmission, the result being a first digest, then encrypting the data and first digest with a symmetric cryptographic algorithm using a secret key as input;
logic for decrypting protected data received over a secure communication path with an asymmetric cryptographic algorithm using an asymmetric public key as input;
logic for decrypting protected data received over a secure communication path with a symmetric cryptographic algorithm using a secret key as input;
logic for computing a one-way hash over a secret key and decrypting protected data received over a secure communication path, the result of the one-way hash computation being a second digest;
logic for computing a one-way hash over a secret key and protected data received over a secure communication path, the result being a second digest, then decrypting the received data with an asymmetric cryptographic algorithm using an asymmetric private key as input;
logic for decrypting a first digest of protected data received over a secure communication path with an asymmetric cryptographic algorithm using an asymmetric public key as input, then computing a one-way hash over data received, the result being a second digest;
logic for computing a one-way hash over a secret key and encrypted data received from a hardware component, the result being a second digest, then decrypting the data received with a symmetric cryptographic algorithm using a secret key as input;
logic for decrypting data received from a hardware component with a symmetric cryptographic algorithm using a secret key as input, then computing a one-way hash over a secret key and the decrypted data, the result being a second digest; and
logic for validating that a second digest matches a received first digest.

48. The ACP of claim 42, wherein the logic for protecting data transmitted over the secure communication path with the hardware component includes, logic for receiving an asymmetric public key; and
logic for validating the asymmetric public key using asymmetric public key registration information,
wherein protecting the data transmitted uses an asymmetric cryptography method.

49. A hardware component for securely communicating with a ACP, the hardware component comprising:
logic for establishing a secure communication path with the ACP; and
logic for protecting data transmitted over the secure communication path with the ACP.

50. The hardware component of claim 49, wherein the logic for establishing the secure communication path with the ACP includes,
logic for generating an asymmetric key pair;
logic for receiving an asymmetric private key over the secure administrative path;
logic for receiving asymmetric public key registration information over the secure administrative path;
logic for receiving an asymmetric public key;
logic for generating a secret key;
logic for receiving the secret key over the secure administrative path;
logic for performing a secret key exchange;
logic for signing secret key exchange messages using the asymmetric private key; and
logic for validating a signed secret key exchange message using the asymmetric public key.

51. The hardware component of claim 50, wherein the logic for performing the secret key exchange includes,
logic for receiving the asymmetric public key; and
logic for validating the asymmetric public key using the asymmetric public key registration information.

52. The hardware component of claim 49, wherein the logic for protecting the data transmitted over the secure communication path with the ACP includes,
logic for encrypting data prior to transmission with an asymmetric cryptographic algorithm using an asymmetric private key as input;
logic for encrypting data prior to transmission with a symmetric cryptographic algorithm using a secret key as input;
logic for computing a one-way hash over a secret key and data to be transmitted, the result of the one-way hash computation being a first digest that is transmitted with the data;
logic for encrypting data prior to transmission with an asymmetric cryptographic algorithm using an asymmetric private key as input, then computing a one-way hash over the encrypted data and a secret key, the result of the one-way hash computation being a first digest that is transmitted with the data;
logic for computing a one-way hash over data to be transmitted, the result being a first digest, then encrypting the first digest with an asymmetric algorithm using an asymmetric private key as input;
logic for encrypting data prior to transmission with a symmetric cryptographic algorithm using a secret key as input, then computing a one-way hash over the encrypted data and a secret key, the result being a first digest transmitted with the encrypted data;
logic for computing a one-way hash over a secret key and data prior to transmission, the result being a first digest, then encrypting the data and first digest with a symmetric cryptographic algorithm using a secret key as input;
logic for decrypting protected data received over a secure communication path with an asymmetric cryptographic algorithm using an asymmetric public key as input;
logic for decrypting protected data received over a secure communication path with a symmetric cryptographic algorithm using a secret key as input;
logic for computing a one-way hash over a secret key and decrypting protected data received over a secure communication path, the result of the one-way hash computation being a second digest;
logic for computing a one-way hash over a secret key and protected data received over a secure communication path, the result being a second digest, then decrypting the received data with an asymmetric cryptographic algorithm using an asymmetric private key as input;
logic for decrypting a first digest of protected data received over a secure communication path with an asymmetric cryptographic algorithm using an asymmetric public key as input, then computing a one-way hash over data received, the result being a second digest;
logic for computing a one-way hash over a secret key and encrypted data received over a secure communication path, the result being a second digest, then decrypting the data received with a symmetric cryptographic algorithm using a secret key as input;
logic for decrypting data received over a secure communication path with a symmetric cryptographic algorithm using a secret key as input, then computing a one-way hash over a secret key and the decrypted data, the result being a second digest; and
logic for validating that a second digest matches a received first digest.

53. The hardware component of claim 49, wherein the logic for protecting the data transmitted over the secure communication path with the ACP includes,
logic for receiving an asymmetric public key; and
logic for validating the asymmetric public key using asymmetric public key registration information,
wherein protecting the data transmitted uses an asymmetric cryptography method.

54. A system for secure communications between an authorized computing platform (ACP) and a hardware component, the system comprising:
the ACP including,
logic for establishing a secure communication path with the hardware component, and
logic for protecting data transmitted over the secure communication path with the hardware component; and
the hardware component being in communication with the ACP.

55. The system of claim 54, wherein the hardware component includes,
logic for establishing the secure communication path with the ACP; and
logic for protecting data transmitted over a secure communication path with an ACP.

56. The system of claim 54, wherein the ACP incorporates a trusted platform module (TPM).

57. The system of claim 54, wherein the ACP further comprises a central processing unit (CPU) executing a trusted boot code base (TBCB) in communications with a trusted platform module (TPM).

58. The system of claim 57, wherein the TPM is physically attached to the ACP.

59. The system of claim 57, wherein the TPM is defined by a Trusted Computing Group compliant trusted platform module.

60. The system of claim 54, wherein the hardware component is defined by one of a chip, a peripheral component interconnect (PCI) card, a PCI-X card, a PCI-Express card, an Infiniband communications adapter, a mezzanine card, a network appliance, a platform, a storage system, a storage subsystem, a printer, a keyboard, a mouse, a mobile phone, a personal data assistant, a service processor provided to allow management of the platform, a peripheral, Trusted Computing Group (TCG) Trusted Platform Module, Trusted Platform Module Peripheral, and a Cryptographic Module compliant with the National Institute of Standards and Technology (NIST) Federal Information Processing Standards Publications (FIPS PUBS) 140-2 standard.
